(19) United States
(12) Patent Application Publication
(10) Pub. No.: US 2006/0209735 A1
(43) Pub. Date: Sep. 21, 2006

(54) Auto realignment of multiple serial byte-lanes

(76) Inventor: David R Evoy, Chandler, AZ (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/567,176

(22) PCT Filed: Aug. 10, 2004
(86) PCT No.: PCT/IB04/51443

§ 371 Date: Feb. 3, 2006

Related U.S. Application Data
(60) Provisional application No. 60/494,294, filed on Aug. 11, 2003.

(51) Int. Cl. H04J 3/08; H04B 7/14

(52) U.S. Cl. 370/315

(57) ABSTRACT

Described is a data communication arrangement (100) with a transmit module adapted to convert parallel data words (102) into a plurality of serial data streams (122, 124, 126, 128), the transmit module arranged in a plurality of groups, with each group including a data-carrying line (122, 124, 126, 128). A receive module (200) is adapted to collect the digital data carried from the transmit module (100) over the plurality of data-carrying lines (122, 124, 126, 128). The receive module (200) detects a frequency compensation code, and in response provides a code-detected signal used for aligning the data back into parallel words and mitigating skew-caused re-training and configuration sequences. The receive module (200) may continuously check alignment between the groups and autonomously correct alignment of the plurality of data groups.

The present invention is directed generally to data communication. More particularly, the present invention relates to methods and arrangements for recovering from and correcting skew errors in data signals transmitted on multiple serial byte lanes.

The electronics industry continues to strive for high-powered, high-functioning circuits. Significant achievements in this regard have been realized through the development of very large-scale integrated circuits. These complex circuits are often designed as functionally-defined modules that operate on a set of data and then pass that data on for further processing. This communication from such functionally-defined modules can be passed in small or large amounts of data between individual discrete circuits, between integrated circuits within the same chip, between remotely-located circuits coupled to or within various parts of a system or subsystem, and between networks of systems. Regardless of the configuration, the communication typically requires closely-controlled interfaces that are designed to ensure that data integrity is maintained while using circuit designs sensitive to practicable limitations in terms of implementation space and available operating power.

The increased demand for high-powered, high-functioning semiconductor devices has lead to an ever-increasing demand for increasing the speed at which data is passed between the circuit blocks. In order to enable high speed, high bandwidth data transfer between two ASIC devices, for example in a backplane, a wide parallel input data word is divided into a smaller number of words, and each smaller word is converted to serial form and then transmitted over a respective sub-link at a high clock rate relative to the system clock. At the receiving side, the clock is recovered from the serial words, and the serial words are converted back to parallel form. An alignment process is then carried out, firstly involving detecting the positions of the bits of the words and then storing the words in a buffer FIFO register. The words are clocked out of the FIFO register in synchronism under control of the system clock once it is detected that valid words are received in the FIFO registers.

In such systems, it is beneficial to ensure that any phase relationship between individual received signals is aligned to provide proper data recovery. There is often an anticipated amount of time “skew” between the transmitted data signals themselves and between the data signals and the receive clock at the destination. There are many sources of skew including, for example, transmission delays introduced by the capacitive and inductive loading of the signal lines of the interconnect, variations in the I/O (input/output) driver source, intersymbol interference and variations in the transmission lines' impedance and length. Regardless of which phenomena cause the skew, achieving communication with proper data recovery and correction, for many applications, should take this issue into account.

Accordingly, there is a need to improve data communication over multiple serial byte lanes, which would lead to more practicable and higher-speed data communication which, in turn, would permit higher-powered, higher-functioning circuits that preserve data integrity and are sensitive to such needs as reducing implementation space and power consumption. There is a particular need to correct skew between multiple lanes and to correct alignment within lanes.

Various aspects of the present invention are directed to data transfer over communication line circuits in a manner that addresses and overcomes the above-mentioned issues.

Consistent with one example embodiment, the present invention is directed to a data communication arrangement with a transmit module adapted to convert parallel data words into a plurality of serial data streams. The transmit module may be arranged in a plurality of groups, with each group including a data-carrying line. A receive module is also arranged in a plurality of groups, the receive module adapted to collect, for each group, the digital data carried from the transmit module over the plurality of data-carrying lines. The receive module is adapted to detect a frequency compensation code, and in response to detection of the frequency compensation code, provide a code-detected signal to each group in the receive module. The code-detected signal is used for aligning the data collected back into parallel data words and mitigating skew-caused re-training and configuration sequences.

The data communication arrangements' receive module may continuously check alignment between the groups and autonomously correct alignment of the plurality of data groups. The data communication arrangement may also include a retraining sequence delay module adapted to delay a retraining sequence request and provide a retry data transmit request in response to frequency compensation codes.

In another embodiment, the data communication arrangement uses frequency compensation codes to automatically correct synchronization errors between the plurality of groups. The data communication arrangement may include at least one bit-shift pointer adapted to shift serial data by at least one bit in response to the code detected signal. The data communication arrangement may also include a direction indicator adapted to provide an indication of the shift direction for the bit-shift pointer.

In yet another embodiment of the present invention, a data communication arrangement includes a parallel circuit having a plurality of parallel to serial conversion modules, each parallel to serial conversion module adapted to serially transmit a portion of the data from the parallel circuit. Each portion of data is transmitted with an embedded frequency compensation code. An alignment circuit is included, having a plurality of serial to parallel conversion modules. Each serial to parallel conversion module is adapted to receive a serial bit stream from the parallel circuit and each serial to parallel conversion module is connected in parallel to a FIFO. The alignment circuit is adapted to provide an alignment detection signal to a data shift circuit in response to detection of the frequency compensation code for each portion of data received, and adaptively shift the serial bit stream in response to the alignment detection signal.

Another embodiment of the present invention discloses a method for aligning multiple byte lanes including the steps of: ) converting parallel data into a plurality of serial data streams, wherein the data streams are encoded with frequency compensation codes; B) transmitting serial data over a plurality of byte lanes; C) receiving serial data from a plurality of byte lanes; and D) converting serial data streams from a plurality of byte lanes into parallel data, wherein the parallel data is aligned using the frequency compensation codes.

Another embodiment of the present invention discloses a PCI Express bus receiver with an alignment circuit having a plurality of serial to parallel conversion modules. Each serial to parallel conversion module is adapted to connect to a PCI Express bus line and convert a serial bit stream to parallel data words. Each serial to parallel conversion module is also connected in parallel to a FIFO. The alignment circuit is adapted to provide an alignment detection signal to a data shift circuit in response to detection of a frequency compensation code for each portion of data received, and adaptively shift the serial bit stream in each serial to parallel conversion module in response to the alignment detection signal. The alignment circuit may continuously check alignment between the plurality of serial to parallel conversion modules and autonomously correct alignment between the plurality of serial to parallel conversion modules.

The invention may be more completely understood in consideration of the following detailed description of various embodiments of the invention in connection with the accompanying drawings, in which:

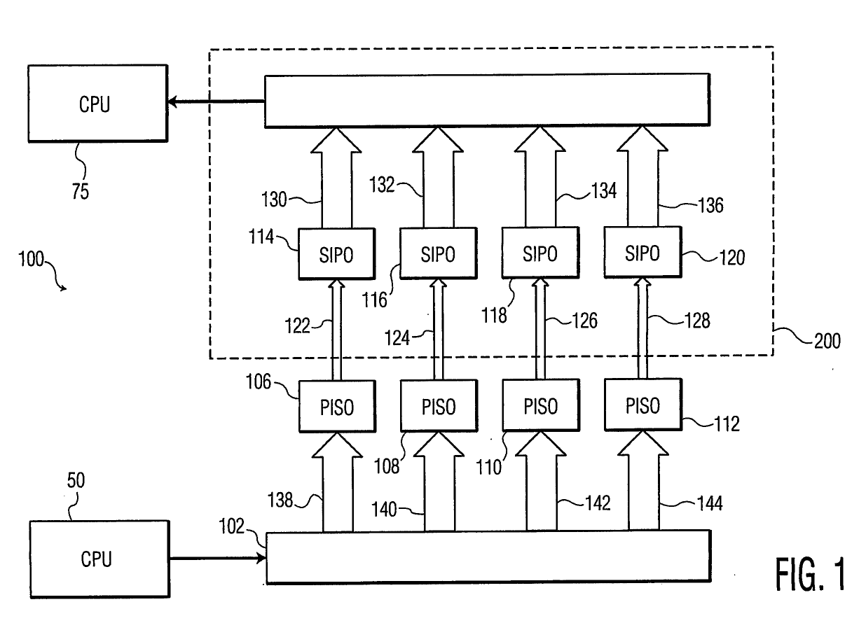

FIG. 1 is a diagram of an example data communication arrangement in which digital data is transferred on multiple serial paths from a first module to a second module over a communication channel including a plurality of data-carrying lines, according to the present invention;

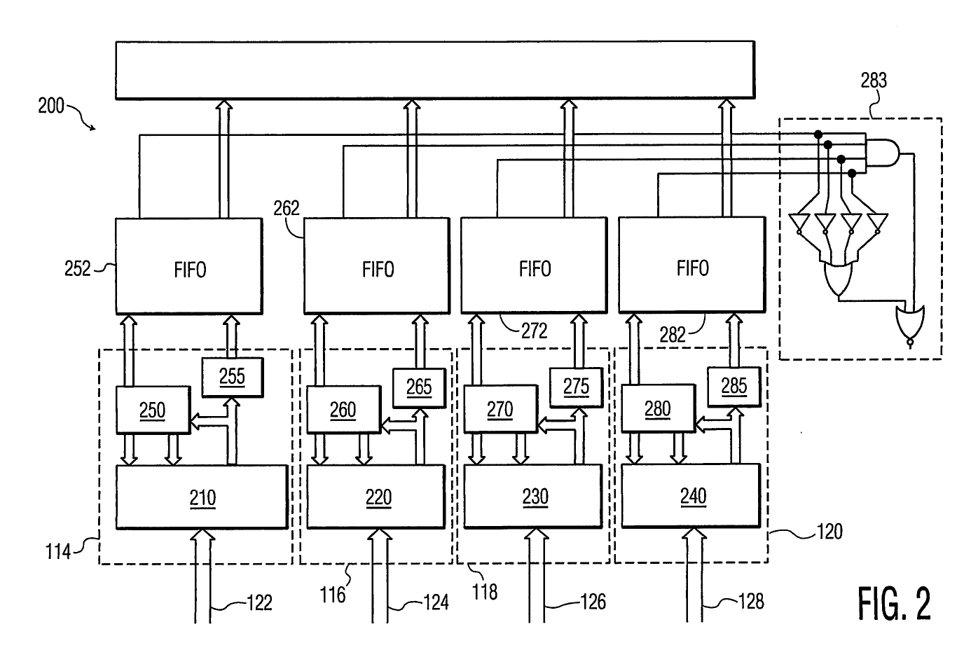

FIG. 2 is a magnified diagram of the receiving module illustrated in FIG. 1; also according to the present invention;

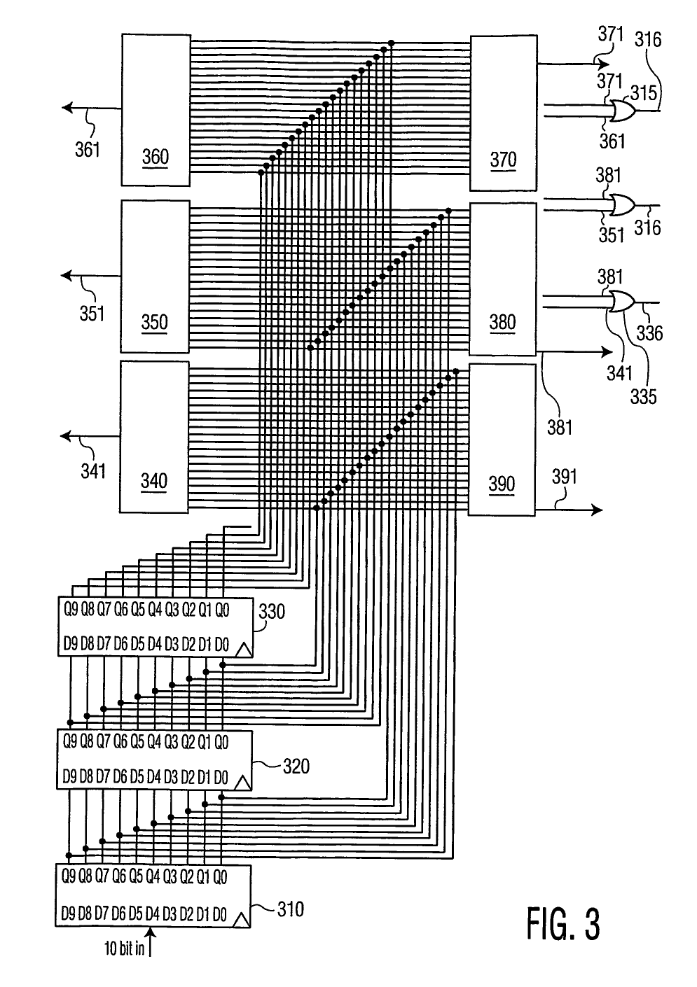

FIG. 3 illustrates a data alignment detection arrangement; and

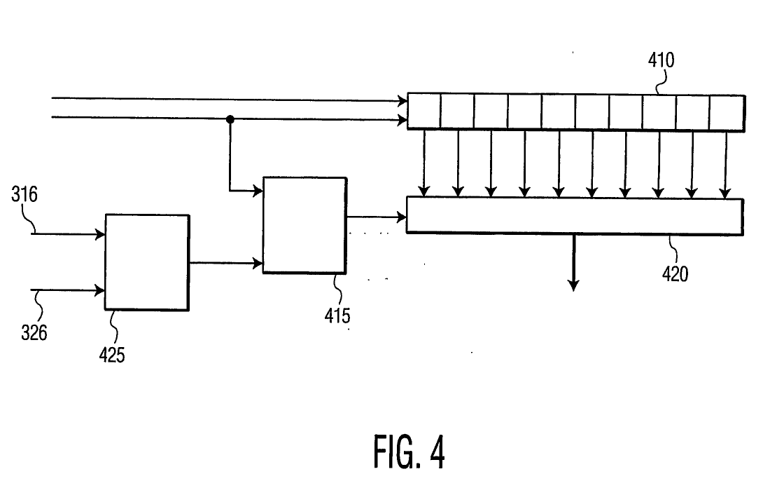

FIG. 4 illustrates a de-skew shifting arrangement.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

The present invention is believed to be generally applicable to methods and arrangements for transferring data between two modules (functional blocks) intercoupled by multiple serial data links, also known as byte lanes. The invention has been found to be particularly advantageous for correcting and recovering from high-speed data transfer applications susceptible to data-skew errors. Examples of such applications include, among others, Peripheral Component Interconnect Express (PCI Express); 100 BASE-T4 (Fast Ethernet) interfaces; system-on-chip using paketized internal routers such as where the data communication path intercouples the two modules on a single-chip; and off-board high-speed communication between chips typically situated immediately adjacent each other on the same printed circuit board. While the present invention is not necessarily limited to such applications, an appreciation of various aspects of the invention is best gained through a discussion of examples in such an environment.

According to one example embodiment of the present invention, a data communication arrangement passes digital data on multiple serial data lines between a pair of circuit modules, referred to a sending (or first) module and a receiving (or second) module. Digital data is sent from the first module to the second module over multiple byte lanes susceptible to skewing data carried by the byte lanes. The communication arrangement is designed so that the first and second modules communicate data over the byte lanes in a plurality of groups. Each of the groups includes a data-carrying line. A data processing circuit arranges the sets of data so that they are presented for transmission over the byte lanes in these data groups. Using a multiple of the system clock signal, the data is sent serially onto the multiple byte lanes for reception by the second module.

The second module includes a receive circuit, which may be a serial in parallel out (SIPO) register or a data buffer, a data processing circuit, and a first-in-first-out (FIFO) buffer for each group. Using the clock signal recovered from the data for the group, within each group the received digital data is received at the receive circuit and then processed and passed into the FIFO buffer.

Skew-caused misalignments between the various groups, however, have not necessarily been resolved at this point. From the FIFO buffer, the data collected for each group is further processed, for example, using another FIFO buffer that is sufficiently wide to accept the data from multiple groups (in some applications, all of the groups) for alignment and overcoming any skew at this point in the receive stage. Depending on the backend-alignment effort, in many implementations the larger FIFO can be used to resolve inter-group misalignments of multiple clock periods. If misalignments are not resolved, then an error is generated, and the communication link requires a retraining and configuration sequence.

The FIFOs are used for symbol alignment and to addresses frequency variations between sending and receiving sides. The present invention extends the functionality of these FIFOs to include an ability to realign using the special codes that are used for frequency compensation. Normally the frequency compensation codes, called Skip Codes, are placed into an intermediate stage FIFO but not placed into the final FIFO used to transfer the realigned parallel data words. This allows for minor frequency variations in the sending and transmitting devices. These codes have heretofore not been used for re-alignment nor to recover from errors. The present invention uses these same sequence of codes to auto realign the interface, while still being compatible with current uses.

Referring to FIG. 1, a CPU 50 is illustrated sending data to a CPU 75 via a plurality of serial links 122, 124, 126 and 128, creating a data communication arrangement 100. Data is placed into a storage circuit 102, and split into a plurality of data portions 138, 140, 142 and 144. Each of the portions 138, 140, 142 and 144 are placed into a Parallel In Serial Out (PISO) 106, 108, 110 and 112 respectively. The portions 138, 140, 142 and 144 are then converted to serial data streams and transmitted over the serial links 122, 124, 126 and 128 to a plurality of Serial In Parallel Out's (SIPO's) 114, 116, 118 and 120.

The SIPO's 114, 116, 118 and 120 convert the serial data streams back to a plurality of received parallel data portions 130, 132, 134 and 136 respectively. As described earlier, the data portions 130, 132, 134 and 136 are susceptible to data skew and other transmission difficulties. The data portions 130, 132, 134 and 136 are placed into a receive storage circuit 104, and subsequently transferred to the CPU 75. A receive module 200 in accordance with the present invention is detailed further in FIG. 2.

It should be understood that the elements described in receive module 200 are for description only, to aid in the understanding of the present invention. As is known in the art, elements described as hardware may equivalently be implemented in software. Reference to specific electronic circuitry is also only to aid in the understanding of the present invention, and any circuit to perform essentially the same function is to be considered an equivalent circuit

Referring to FIG. 2, the receive module 200 includes the SIPO's 114, 116, 118 and 120 that are shown to include a plurality of shift registers 210, 220, 230 and 240 respectively. The shift registers 210 220, 230 and 240 provide parallel data to a plurality of FIFO's 252, 262, 272 and 282 respectively. At least one bit from each FIFO 252, 262, 272 and 282 is used by an alignment detect circuit 283, that provides a signal ultimately used to notify the shift registers 210, 220, 230 and 240 to shift their data streams upon detection of errors.

The SIPO's 114, 116, 118 and 120 are adapted to shift their data at least one bit early or late via direction from a detect align module 250, 260, 270 and 280 respectively. In an alternate embodiment of the present invention, the SIPO's 114, 116, 118 and 120 are also adapted to remove sequences such as, for example, COMMA codes and Skip sequences via a plurality of drop Skip modules 255, 265, 275 and 285 respectively. By dropping COMMA and Skip sequences before loading data into the FIFO's 252, 262, 272 and 282, the FIFO's may be used directly for input into the CPU 75 (FIG. 1) without need for the receive storage circuit 104, and with improved functionality and data correction for bit-level skew error.

FIG. 3 illustrates one implementation of the detect align modules 250, 260, 270 and 280. As the receiver's data arrives, the detect align module retains a new symbol 310, a previous symbol 320, and an oldest symbol 330. As will be more fully described below, all three symbols are compared by a plurality of skip sequence compare modules 340, 350, 360, 370, 380 and 390. The skip sequence modules 340, 350 and 360 compare the symbols for aligned, late and early conditions, and provide an aligned negative indication 341, a late negative indication 351, and an early negative indication 361. The skip sequence modules 370, 380 and 390 compare the symbols for aligned, late and early conditions, and provide an aligned positive indication 391, a late positive indication 381, and an early positive indication 371.

A plurality of OR gates 315, 325 and 335 receive the indications 341, 351, 361, 371, 381 and 391 to provide an early signal 316, a late signal 326 and an aligned signal 336. The early signal 316 and late signal 326 are provided to the shift register's 210, 220, 230 and 240 to correct errors as will be more fully described below and in FIG. 4. The aligned signal 336 is provided to FIFO's 252, 262, 272 and 282 for the use of the alignment detect circuit 283.

FIG. 4 illustrates a shift arrangement illustrating an implementation of a bit-level de-skew such as the shift register's 210, 220, 230 and 240. A bit-level de-skew arrangement 400 includes a shift register 410 combined with a latch 420. A counter 415 provides a signal to the latch 420 when properly de-skewed data is available for latching. A length control module 425 receives the early signal 316 and late signal 326, and provides a length for the counter 415 to count to provide properly bit-level de-skewing within a symbol or data word. For example, normally the counter 415 counts to 10 bits of serial data before latching a symbol. If a one bit early condition is detected, the length control module 425 would provide a new count length of 11 for the latch 420. Likewise, for a one bit late condition, the counter 415 would only count to 9 before latching the de-skewed symbol. Following is a description of the function of the present invention.

The present invention includes the addition of a bit to the FIFO that uniquely identifies when all outputs should be aligned. This additional bit is placed into the FIFO along with useful data and or symbols. This accommodates the case when the reading side of the FIFO runs at a speed that is lower then the sending rate without the requirement of any additional Skip Codes. It is possible to use a Skip sequence that is only intended to allow for frequency variation to continuously auto re-align all separate serialization shift registers and FIFOs.

Use of this technique never causes the inputs to the FIFO to wait. All inputs are written independently. This technique also never causes valid outputs of the FIFO to wait or stall. Only aligned words can be used, so no performance penalty or extra FIFO depth is required. An extra bit of FIFO width per lane and minimal logic is all that is added for the detection. Use of this technique for auto realignment requires the addition of some way to shift the byte lanes.

Initial Assumptions are that all lanes get identical skew sequences and all skew sequences are aligned at the transmitter. The skew sequences contain Skip characters that are not parallel data to be recovered. The receive and transmit FIFOs run at almost identical speeds, but either one can be slightly faster or slower then the base rate. Each FIFO has a bit dedicated to the ALIGN flag.

Input Dide of FIFO:

Always insert all COM characters

Never insert Skip characters

A COM->SKIP sequence sets a flag called ALIGN_PENDING[n], when n is the lane number.

The ALIGN[n] flag is set in the FIFO when the ALIGN_PENDING[n] is set and any value is written into the FIFO and the ALIGN_PENDING[n] is cleared. (This has the effect of tagging the first data or K code following a Skip sequence with a ALIGN[n] flag.)

Output Side of the FIFO:

The FIFOs can only be read when all the FIFO ready flags are true indicating a full word is ready

If all ALIGN[m:0] flags are equal to 0, the transfer is assumed to be in alignment

If all ALIGN[m:0] flags are equal to 1, the transfer is in alignment

If some ALIGN[m:0] flags are equal to 1 and some are equal to 0, an alignment error has occurred.

It is reasonable to limit the auto skew adjustment to a single clock (a single clock in the serial clock domain), during normal operation. However, during training sequences, this could be extended to allow for the correction of multiple clock skew errors. As an example:

Assume a 4-lane link for all following examples.

Align detect=0000 (This is a normal sequence, with no flags set. If all FIFOs are ready, all the contents of the aligned work can be assumed to be aligned and valid.)

Align detect=1111 (Each lane contains the first character following an alignment sequence. If all FIFOs are ready, all the contents of the aligned work can be assumed to be aligned and valid.)

Align detect=1101 (Three of the lanes have valid aligned data. If all FIFOs are valid, this is an error. Self alignment requires advancing the lanes missing the align flag. Data corruption will have occurred, but advancing the trailing lanes will auto realign the FIFOs and detect the error sooner.)

There are many possible actions available when an alignment error has occurred and been detected. This type of error is normally not detected at this level. However, detection of fatal errors at this level will reduce recovery time and improve lane and link synchronization. In particular, the sequence when analyzing startup/configuration sequences will be made much more redundant. To facilitate these goals, the following is a description of the use of this detection to achieve auto alignment:

Upon detection of an alignment error, use the detection of one bit early or one bit late and adjust the 10 bit shift register that is converting from 1 bit in to 10 bit codes accordingly.

Reset all receive FIFOs and clear the serial to parallel in sync flags, starting a new search for byte synchronization.

Advance trailing FIFOs

Alignment Detection

The function of the Align Detection is to detect the alignment of the Skip sequences. A Skip sequence is, typically, a Comma code followed by one or more Skip Codes. The Align Detect block detects this sequence, and also detects two additional sequences, a Skip sequence that is one bit early and a Skip sequence that is one bit late. (This could be extended to also detect Skip sequences that are multi bit early and multi bit late.)

Normal properly aligned Skip Sequences

A normal correctly aligned Skip sequence can occur with positive or negative outstanding disparity. This results in two valid Skip sequences, a +comma followed by one or more Skip sequences and a −comma followed by one or more Skip sequences. The following bit sequences all represent legal, properly aligned Skip sequences.

Skip Code Sequence with Negative Outstanding Disparity:

DATA(n), +comma, −Skip, +Skip, (some number of alternating +−Skip Codes), DATA(n+1)

(DATA(n), 0011111010, 1100001011, 0011110100, DATA(n+1))

Skip Code Sequence with Positive Outstanding Disparity:

DATA(n), −comma, +Skip, −Skip, (some number of alternating +−Skip Codes), DATA(n+1)

(DATA(n), 1100000101, 0011110100, 1100001011, DATA(n+1))

The Detect align module 250, 260, 270 and 280 generates the Align flag when either of the two above sequences are observed. The DATA(n+1) symbol is flagged with the Align flag following either of the two above sequences. In the event of a missed or inserted serial clock in the data stream the above sequences will be delayed or early by a single bit. The Skip sequences are a periodic known sequence that can be used to detect with a high degree of accuracy this fatal type of error and enable the correction of this error on the fly. Detecting these sequences is complicated by the fact that the sequences are monitored at a parallel 10 bit interface but the error is at the bit level.

Early Skip Code Sequence with Negative Outstanding Disparity:

(DATA(n), xxxxxxxxx0, 0111110101, 100001011x,)

Earlyskip Code Sequence with Positive Outstanding Disparity:

DATA(n), −comma, +Skip, −Skip, (some number of alternating +−Skip Codes), DATA(n+1)

(DATA(n), xxxxxxxxx1,1000001010, 011110100x,)

Late Skip Code Sequence with Negative Outstanding Disparity:

DATA(n), +comma, −Skip, +Skip, (some number of alternating +−Skip Codes), DATA(n+1)

(DATA(n), x001111101, 0110000101, 1xxxxxxxxx,)

Late Skip Code Sequence with Positive Outstanding Disparity:

DATA(n), −comma, +Skip, −Skip, (some number of alternating +−Skip Codes), DATA(n+1)

(DATA(n), x110000010, 1001111010, 0xxxxxxxxx, DATA(n+1))

Implementation of the Aligned, Early, Late Skip Code

For simplicity, only the sequences that start with a negative disparity are considered. Positive disparity sequences follow functionally equivalent logical paths but for opposite polarity and direction. This circuit actually checks both types of running disparity. In the instant embodiment, the last three bytes (symbols) received from the serial bit stream are examined to see if a Skip sequence is present. By selecting the appropriate bits from a history of the last three bytes, an aligned sequence is found in the last two bytes, and the early and late sequences are found in various bits of the last three bytes as shown in FIG. 3.

In a properly aligned data stream it is guaranteed that the Skip sequences will be detected only for actual Skip sequences. However, it is possible that a good stream could have false Early and Skip Code sequence detections. This is acceptable and causes no problems or false corrections. It is also possible that a bit stream that is early could falsely detect an aligned Skip Code or a late Skip Code in normal data. It is possible that a bit stream that is late could falsely detect an aligned Skip code or an early Skip Code sequence. A properly aligned data stream will always correctly generate the Aligned flags. Corrections should only be made to the bit stream when a single lane is in error, using the previously describe error detection from the multiple alignment flags. The lane in error can then use last observed Skip Code sequence alignment, early, late or aligned, to make a best guess at the appropriate correction.

No correction should be made if the last observed alignment was aligned, but if the last observed alignment of a Skip Code was early, then the serial to parallel should be delayed a single bit clock, and if the alignment of the last observed Skip sequence was late, then the stream should be moved early by advancing the serial stream a single bit or retarding it 9 bits.

Accordingly, various embodiments have been described as example implementations of the present invention for addressing skew issues in multiple byte lane applications. In each such implementation, skew across groups is re-aligned and corrected without the need for a retraining and configuration sequence by using frequency compensation codes to re-align and recover from data skew errors.

The present invention should not be considered limited to the particular examples described above. Various modifications, equivalent processes, as well as numerous structures to which the present invention may be applicable fall within the scope of the present invention. For example, multi-chip or single-chip arrangements can be implemented using a similarly constructed one-way or two-way interface for communication between the chip-set arrangements. Such variations may be considered as part of the claimed invention, as fairly set forth in the appended claims.

What is claimed is:

1. A data communication arrangement, comprising:
a transmit module adapted to convert parallel data words into a plurality of serial data streams, each of which is carried by a data-carrying line; and
a receive module adapted to collect, for each data-carrying line, data carried from the transmit module by the data-carrying lines, and adapted to detect therein a frequency compensation code and, in response thereto, align the data carried from the transmit module.

2. The data communication arrangement according to claim 1, wherein the receive module continuously checks alignment between the serial data streams and autonomously corrects alignment between the serial data streams.

3. The data communication arrangement according to claim 1, wherein the receive module includes a retraining sequence delay circuit adapted to delay a retraining sequence request and provide a retry data transmit request in response to the frequency compensation codes to mitigate skew-caused re-training and configuration sequences.

4. The data communication arrangement according to claim 1, wherein the frequency compensation code is a Skip code.

5. The data communication arrangement according to claim 1, wherein the receive module includes at least one shift register adapted to shift the serial data stream by at least one bit in response to the frequency compensation code.

6. The data communication arrangement according to claim 1, wherein the receive module includes at least one bit-shift pointer adapted to shift the serial data by at least one bit in response to the frequency compensation code.

7. The data communication arrangement according to claim 6, wherein the receive module includes a direction indicator adapted to provide an indication of the shift direction for the bit-shift pointer.

8. A data communication arrangement, comprising:
a parallel word storage circuit having a plurality of parallel to serial conversion modules, each parallel to serial conversion module adapted to serially transmit a portion of the data from the parallel word storage circuit, each portion of data transmitted with an embedded frequency compensation code; and
an alignment storage circuit having a plurality of serial to parallel conversion modules, each serial to parallel conversion module adapted to receive the portions of data from the parallel word storage circuit and each serial to parallel conversion module connected in parallel to a FIFO, the alignment storage circuit adapted to provide an alignment detection signal to a data shift circuit in response to detection of the frequency compensation code for each portion of data received, and adaptively shift the parallel data output from the portions of data in response to the alignment detection signal.

9. The data communication arrangement according to claim 8, wherein the alignment storage circuit includes a retraining sequence delay module adapted to delay a retraining sequence request and provide a retry data transmit request in response to the frequency compensation code.

10. The data communication arrangement according to claim 8, wherein the frequency compensation code is a Skip code.

11. The data communication arrangement according to claim 10, wherein the SKIP codes are dropped and not placed into the FIFO.

12. A PCI Express bus receiver, comprising:
an alignment storage circuit having a plurality of serial to parallel conversion modules, each serial to parallel conversion module adapted to connect to a PCI Express bus line and convert a serial bit stream to parallel data words, and each serial to parallel conversion module connected in parallel to a FIFO, the alignment storage circuit adapted to provide an alignment detection signal to a data shift circuit in response to detection of a frequency compensation code for each serial bit-stream, and adaptively shift the parallel data output from the serial bit stream in each serial to parallel conversion module in response to the alignment detection signal.

13. The PCI Express bus receiver according to claim 12, wherein the alignment storage circuit continuously checks alignment between the plurality of serial to parallel conversion modules and autonomously corrects alignment between the plurality of serial to parallel conversion modules.

14. The PCI Express bus receiver according to claim 12, wherein the alignment storage circuit includes a retraining sequence delay module adapted to delay a retraining sequence request and provide a retry data transmit request in response to the frequency compensation code.

15. The PCI Express bus receiver according to claim 12, wherein the alignment storage circuit uses the frequency compensation codes to automatically correct synchronization errors between the plurality of serial to parallel conversion modules.

16. The PCI Express bus receiver according to claim 12, wherein the alignment storage circuit includes at least one shift register adapted to shift the serial bit stream by at least one bit in response to the alignment detection signal.

17. The PCI Express bus receiver according to claim 12, wherein the alignment storage circuit includes at least one bit-shift pointer adapted to shift the serial data by at least one bit in response to the alignment detection signal.

18. The PCI Express bus receiver according to claim 17, wherein the alignment storage circuit includes a direction indicator adapted to provide an indication of the shift direction for the bit-shift pointer.

19. A method for aligning multiple byte lanes, comprising:
converting parallel data into a plurality of serial data streams, wherein the data streams are encoded with frequency compensation codes;
transmitting serial data over a plurality of byte lanes;
receiving serial data from a plurality of byte lanes; and
converting serial data streams from the plurality of byte lanes into parallel data, wherein the parallel data is aligned using the frequency compensation codes.

20. The method of claim 19, wherein the serial data is transmitted over a PCI Express bus.

21. The method of claim 19, wherein the serial data is transmitted over a fast Ethernet connection.

22. A data communication arrangement, comprising:
a means for converting parallel data into a plurality of serial data streams, wherein the data streams are encoded with a frequency compensation code;
a means for transmitting serial data over a plurality of byte lanes;
a means for receiving serial data from a plurality of byte lanes; and
a means for converting serial data streams from a plurality of byte lanes into parallel data, wherein the parallel data is aligned using the frequency compensation code.

23. The data communication arrangement of claim 22, wherein the frequency compensation code includes a comma code.

24. The data communication arrangement of claim 22, wherein the frequency compensation code includes a Skip code.

25. The data communication arrangement of claim 23, wherein the frequency compensation code includes a Skip code.

26. A data communication arrangement, comprising:
a parallel circuit providing data symbols in serial form on a plurality of data lines, at least some of the data symbols including codes useful for frequency compensation; and
an alignment circuit adapted to respond to the codes by aligning the data symbols and by removing the codes.

27. The data communication arrangement according to claim 26, wherein the alignment circuit includes a retraining sequence delay module adapted to delay a retraining sequence request and provide a retry data transmit request in response to the codes.

28. The data communication arrangement according to claim 26, wherein the alignment circuit includes a shift register adapted to reverse shift directions.

29. The data communication arrangement according to claim 26, wherein the symbols include clock information.

30. The data communication arrangement according to claim 26, wherein the codes are Skip codes.

31. The data communication arrangement according to claim 26, wherein the alignment circuit adaptively shifts the serial data to detect the codes.

32. A method for de-skewing data, comprising:
converting parallel data into a plurality of serial bit-streams;
inserting frequency compensation codes into at least one of the bit-streams;
transmitting the plurality of serial bit-streams over a plurality of parallel byte lanes, the parallel byte lanes susceptible to data skewing;
receiving the plurality of serial bit-streams;
performing a one-bit shift of the at least one of the bit-streams; and
dropping the frequency compensation codes from the at least one of the bit-streams before converting the plurality of serial bit-streams back into parallel data.

33. The method of claim 32, further comprising determining a shift direction before performing the one-bit shift.

34. The method of claim 32, further comprising determining a bit-count before performing a plurality of one-bit shifts, the number of shifts equal to the determined bit-count.

35. The method of claim 32, wherein the frequency compensation codes are Skip codes.
